(19) United States
(12) Patent Application Publication
(10) Pub. No.: US 2021/0146930 A1
(43) Pub. Date: May 20, 2021

(54) DEVICE FOR IMMOBILIZING A VEHICLE

(71) Applicant: Olivier ESTENNE, Neuilly-Sur-Seine (FR)

(72) Inventor: Olivier ESTENNE, Neuilly-Sur-Seine (FR)

(21) Appl. No.: 16/764,852

(22) PCT Filed: Oct. 19, 2018
(86) PCT No.: PCT/FR2018/000236

§ 371 Date: Aug. 10, 2020

(30) Foreign Application Priority Data
Nov. 17, 2017 (FR) 1771232

(51) Int. Cl. B60W 30/18; B60R 19/48; B60W 10/06; B60W 10/18

(52) U.S. Cl. CPC B60W 30/18172; B60R 19/48; B60W 2554/80; B60W 10/18; B60W 2556/60; B60W 10/06

(57) ABSTRACT

The present invention relates to a vehicle immobilization device (1) comprising at least one impact detector (2), at least one circuit breaker (3) configured able to stop the engine of the vehicle (1), a restart system (4) configured to deactivate the circuit breaker (3) and allow the vehicle to be restarted, and a control unit, characterized in that the restart system (4) comprises a manually operable device (5) conditioning the restarting, the manually operable device (5) being arranged at a location which is inaccessible to a driver in the vehicle's driver's station.

The present invention also relates to the use of an immobilization device according to the invention.

The present invention is in the field of urban security. It concerns more particularly a vehicle immobilization device making it possible to limit the effectiveness of car-ramming terrorist attacks, and to make it more difficult to hit-and-run after an accident. The device could also make it possible to inform the authorities quickly in the event of an accident.

Terrorist attacks are today a major problem of our societies. The so-called “car-ramming” attacks, which have been on the increase in recent years, are particularly deadly. These attacks consist, for the attacker, of driving a vehicle in a pedestrian zone, hitting and crushing passers-by on the road. The attacker usually stops only when forced to do so by an obstacle or by the intervention of the police.

There is currently no satisfactory solution to combat car-ramming attacks. The main measures taken against this type of attack are the installation of protective bollards or the modification of traffic plans. These measures are by definition limited to certain restricted geographical areas and do not allow to effectively combat the problem.

Document GB1406451 proposes a vehicle circuit breaker that can be triggered after an impact to prevent the risk of fire. This solution could be suitable to stop a car-ramming attack after a first impact. However, the vehicle can be easily restarted by operating a lever, which could be located in the driver's station, easily accessible for a driver. This solution is therefore not applicable to the fight against car-ramming attacks, for which an immediate restart of the vehicle after the first impact must be prevented.

The present invention is intended to at least partially compensate for these disadvantages by providing a vehicle immobilization device which forces the vehicle to stop after an impact, the driver being obliged to get out of the vehicle in order to restart it. To this end, it proposes a vehicle immobilization device comprising at least one impact sensor, at least one circuit breaker configured able to stop the engine of the vehicle, a restart system configured to deactivate the circuit breaker and allow the vehicle to be restarted, and a control unit, characterized in that said restart system comprises a manually operated device, conditioning the restarting, said manually operated device being arranged at a place inaccessible to a driver who is in the vehicle's driver's station.

Thanks to these provisions, in the event of a car-ramming terrorist attack, the vehicle will be stopped at the first impact, the attacker being unable to continue the attack without getting out of the vehicle, which makes it easier for the law enforcement agents to apprehend him. Similarly, in the event of an accident, the risk of hit-and-run is reduced, as the driver of the vehicle cannot immediately leave the scene after the impact.

According to other features:
said manually operated device can be placed under the front bonnet of the vehicle, which is a simple and effective embodiment, since this space is usually not accessible from the passenger compartment of the vehicle, and the manually operated device and the circuit breaker can then be placed close to the vehicle battery,
said manually operated device may comprise at least a base, and a handle movable with respect to the base, which is a simple means of performing an mechanical type activation,
said at least one impact sensor may be arranged on a bumper of the vehicle, as this location of the vehicle usually suffers most impacts, so that impacts will be detected with a high probability,
said at least one impact sensor can be a deceleration sensor and/or a bump sensor, which can preferably be placed inside a tamper-proof housing, thereby increasing the security of the immobilization device,
said immobilization device may further include a brake actuator, configured to actuate the vehicle brakes upon activation of the at least one impact sensor, thereby allowing the vehicle to be immobilized more quickly and efficiently in the event of an impact,
said immobilization device may further comprise a GPS beacon, as well as a transmitter, capable of sending information to a control center, so that the control center can monitor the state of the immobilization device, be alerted in the event of activation of the circuit breaker, a breakdown or an attempt to neutralize the immobilization device, and if necessary be capable of locating the vehicle.

The present invention also relates to a use of an immobilization device according to the invention, in which the neutralization of the circuit breaker causes an alert to be sent to said control center.

Thanks to these provisions, a vehicle 1 whose immobilization system is not operating is immediately located by the control center.

The present invention also relates to a use of an immobilization device according to the invention, in which the control unit is configured to be in a normally active state, so that the removal or neutralization of at least one piece of equipment of the immobilization device other than the circuit breaker produces the activation of the circuit breaker.

Thanks to these provisions, a vehicle 1 with a non-functioning immobilization system is immediately immobilized.

The present invention also relates to the use of an immobilization device according to the invention, in which the activation of the restart system requires at least two separate movements of the handle relative to the base.

These provisions ensure that the restarting of vehicle 1 is not too quick, and make it more difficult to make unauthorized modifications to the immobilization device to allow restarting from the driver's station.

The present invention will be better understood by reading the detailed description which follows, with reference to the annexed figures in which:

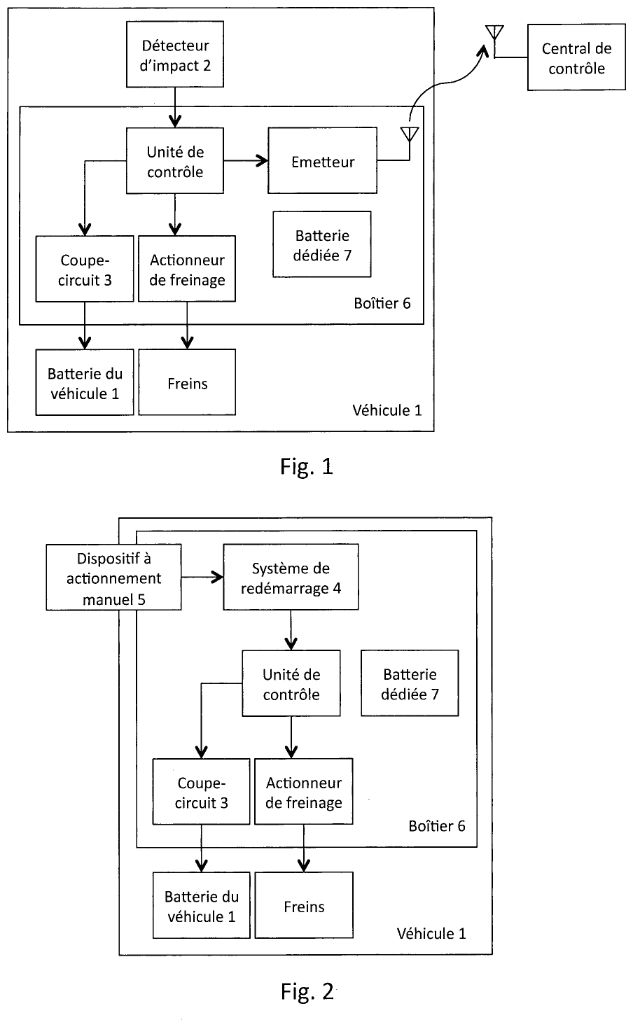

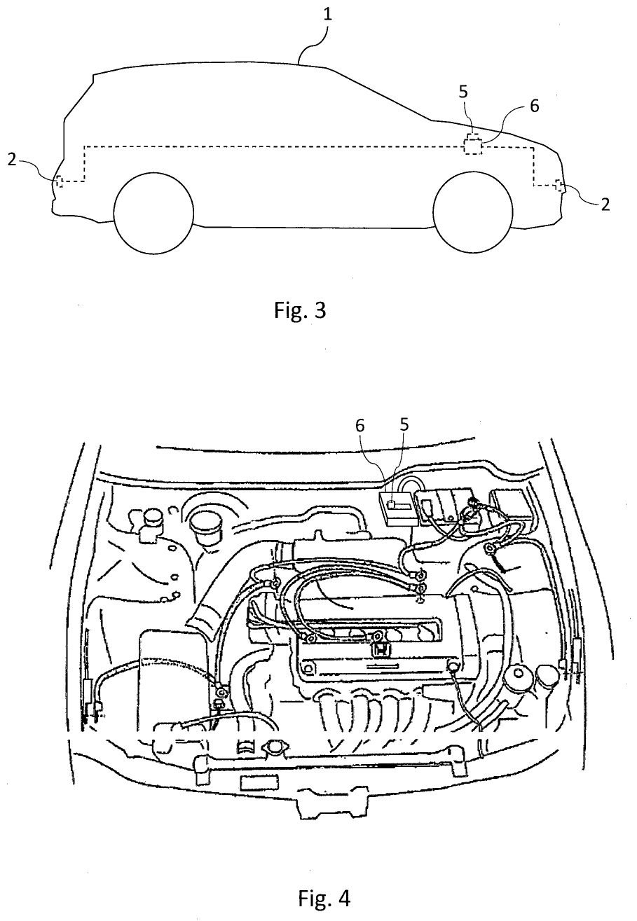

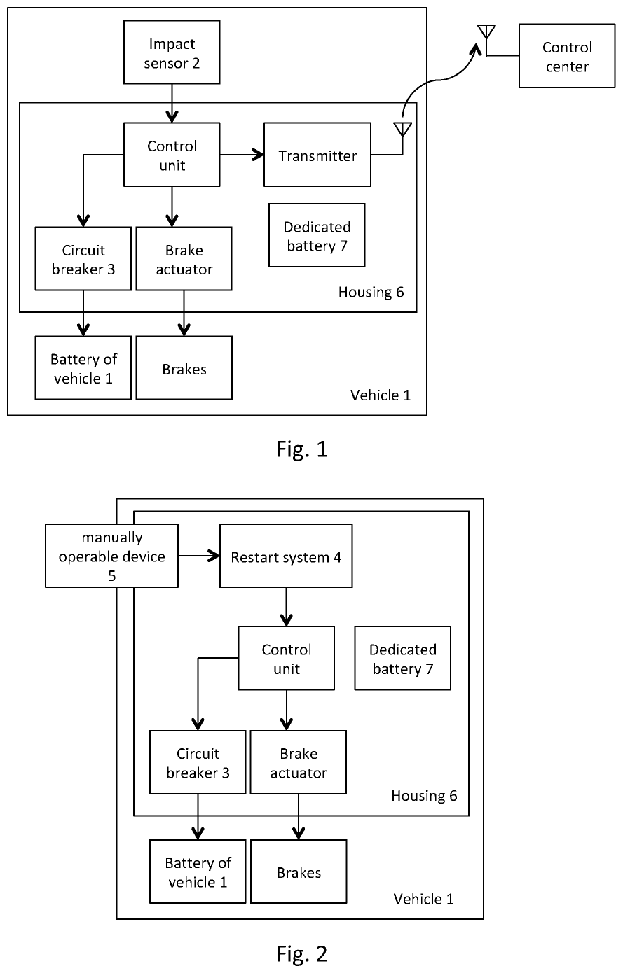

FIG. 1 is a schematic side view of a vehicle comprising an immobilization device according to a mode of realization of the invention.

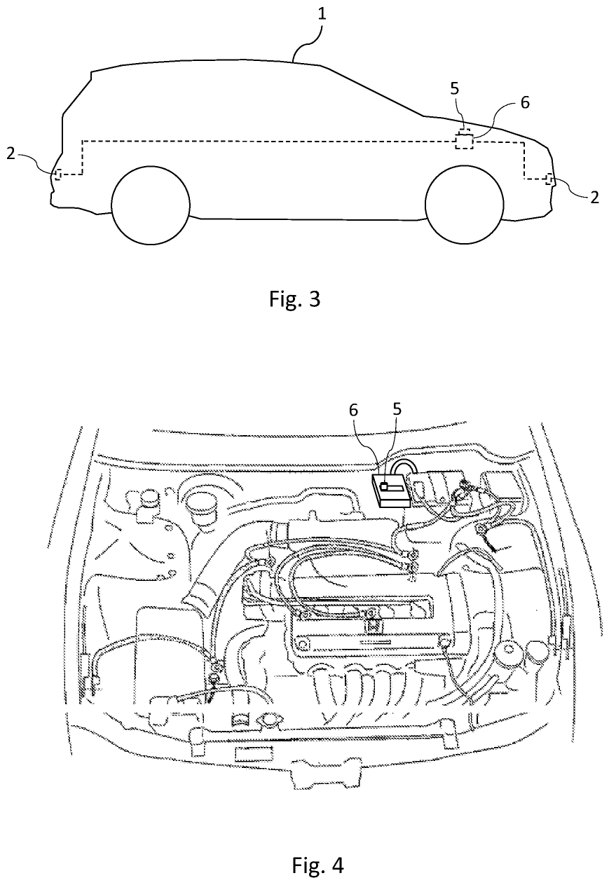

FIG. 2 is a view of a detail of FIG. 1.

The invention relates to an immobilization device arranged in a vehicle 1. The vehicle may be any motor vehicle that can be used for a car-ramming attack, for example a car, a van or a truck. The engine may be a petrol or diesel, gas or electric motor.

The immobilization device has one or more impact sensors 2, which may be located on the body of the vehicle 1. The impact sensors 2 may, for example, be shared with the airbag system or they may be dedicated sensors. For example, impact sensor 2 may be located on the front and rear bumpers of vehicle 1. Impact sensors 2 can also be deceleration sensors and/or bump sensors, for example in a housing.

The impact detection threshold may be chosen lower than the threshold used by the airbags, as the objective is to detect even small impacts. Care must be taken in setting the threshold to avoid inadvertent activation of the system, for example for a touch during a parallel parking, but to ensure that the system is triggered in the event of an impact which could cause injury to a third party.

The immobilization device includes a control unit, configured to receive impact detection information and send commands to various outputs.

The immobilization device also includes a circuit breaker 3. In the event of an impact detected by the impact sensor 2, the circuit breaker 3 is configured to automatically immobilize the vehicle, for example by turning off the electrical circuit of the vehicle 1 to stop the engine. For example, this can be done directly to the battery of vehicle 1. For vehicles with more than one engine, such as hybrid vehicles, the man of the art will be able to adapt the solution to allow the vehicle to be immobilized.

The immobilization device may comprise a brake actuator, allowing it to act on the brakes of vehicle 1 in addition to the electrical circuit, in order to bring vehicle 1 to a stop more quickly and effectively after an impact.

The immobilization device also comprises a manual restart system 4, enabling the electrical circuit of vehicle 1 to be re-established after it has been cut off by the action of circuit breaker 3 and, if necessary, to release the brakes to enable vehicle 1 to be restarted. The restart system 4 is located in vehicle 1 so that the driver is obliged to leave his driver's station to operate it manually by means of a manually operated device 5. For example, the restart system 4 may be located under the bonnet of vehicle 1, preferably close to the battery of vehicle 1.

Alternatively, the restart system 4 may be placed in the boot, or under the boot where a spare wheel is usually located. It can also be placed under a rear seat, or under the front passenger seat, in a manner inaccessible to a driver seated at the vehicle's driver's station.

In a preferred embodiment of the invention, restarting vehicle 1 by means of the restart system 4 requires a time-consuming operation, such as a succession of manual operations. For example, the manually operated device 5 may have a base, and a handle which is movable relative to the base. The activation of the restart system then preferably requires at least two separate movements of the handle relative to the base, for example a rotation in one direction and then in the other direction, or a rotation until translation is possible, followed by translation, or a translation to a point where rotation is possible, followed by rotation. Finally, it can be arranged that these operations can only be performed by an authorized user, for example by the use of a specific mechanical key, code or fingerprint.

For example, it can be arranged that the driver registers his fingerprint at the time of acquiring the vehicle 1 comprising the immobilization device, whether it is a purchase or a lease, so that this fingerprint can be used in the manually operated device 5. In another embodiment of the invention, restarting can be done by entering a code into the manually operated device 5. This code can be sent by the control center to the driver, for example by text message, at the request of the driver after the vehicle has been immobilized. In the embodiments where an action by the control center is required to restart vehicle 1, it can be expected that this action will be subject to certain criteria, for example a declaration by the driver on the causes of activation of the circuit breaker 3.

The immobilization device may include a GPS beacon, enabling vehicle 1 to be located at any time. In the event of an activation of circuit breaker 3 and then of the manual restart system 4, it is thus possible to provide for the location information of vehicle 1 to be transmitted via a wireless transmitter in order to locate the location of the impact. For example, the information can be sent to a control center, which manages its processing and storage. If vehicle 1 is not quickly restarted via the restart system 4, it is likely that a serious accident or attack has occurred. The control center can then inform the police or emergency services. The presence of a GPS beacon in the immobilization device can also be used by the owner of a stolen vehicle, for example via a smartphone application.

The immobilization device may comprise a casing 6, in which the control unit, a dedicated battery 7, independent of the vehicle battery 1, the circuit breaker 3, as well as the restart system 4, and possibly the GPS beacon, can be placed. The casing 6 may also contain the impact sensor, for example in the form of a deceleration sensor and/or bump sensor. Box 6 is designed in such a way that it cannot be removed or opened by the user of vehicle 1 without authorization. It can be provided that any unauthorized attempt to disassemble casing 6 is detected by the immobilization device, for example by a sealing system, and an alert can then be sent to the control center. It is then easy to locate vehicle 1 and ensure that it is not about to be used as a ram vehicle.

The system can be normally active, and an alert can be sent to the control center for any neutralization or attempt to neutralize the system, whether this is due to a breakdown or voluntary action. The sending of alerts can be combined with the activation of circuit breaker 3 to make the vehicle 1 unusable without a functioning immobilization device.

The control unit can manage the interactions between sensors 2, circuit breaker 3 and the manual restart system 4, and possibly the GPS beacon, and send alerts to the control center.

In the event of a terrorist attack, the vehicle will be quickly immobilized after the first impact, thus preventing the driver from carrying out a car-ramming attack over a long distance. Indeed, after the first impact, the vehicle will inevitably stop, with or without the brake being blocked. The blocking of the brakes makes it possible to stop it more quickly, and to further reduce the damage incurred. If the attacker wants to restart the vehicle, he has to get out of the vehicle to activate the manual restart system, or if the restart system is not outside the vehicle, it will take him some time. That makes him much more vulnerable and much easier to arrest.

In a particular embodiment of the invention, the immobilization device includes a timer. It can then be foreseen that the manually operated device 4 cannot be used immediately after the action of the circuit breaker, but only after a delay to be defined, for example of the order of one minute. This extends the delay to restart the vehicle, thus reducing the possibility of a hit-and-run offence or of continuing a car-ramming attack.

In the event of a serious accident, if the police and emergency services cannot be called directly by the driver of vehicle 1 or a witness, sending information to a control center can speed up the intervention of the police and emergency services. Finally, in the event of an accident, immobilizing vehicle 1 reduces the risk of a hit-and-run offence, as the driver of vehicle 1 is forced to get out to restart.

The immobilization device can be installed on an existing vehicle 1, or integrated into the manufacture of new vehicles 1.

Provision may be made for each immobilization device to be assigned a serial number, and to be associated with the serial number of the vehicle 1 on which it is mounted. This allows a police authority to control the installation of immobilization devices and to avoid circumvention of the regulations by non-compliant devices, in particular those that are not active or incorrectly calibrated. It also allows an effective control of the equipment of a vehicle, in particular during mandatory technical inspections, but also during a simple police check.

It also enables the control center, when an immobilization device is activated due to an impact or deliberately neutralized, to receive information on the serial number of the neutralized immobilization device, and to be able to deduce the serial number of the vehicle concerned, and therefore the identity of the owner of the vehicle concerned. In the case of a rental car, which is very common in terrorist attacks, this makes it possible to quickly identify the lessee of the rental car. This speeds up the investigation, and in some cases even gives enough time to act to prevent the attack.

Although the above description is based on particular embodiments, it is by no means restrictive of the scope of the invention, and modifications may be made, in particular by substitution of technical equivalents or by different combinations of some or all of the features developed above.

1. Vehicle immobilization device (1) comprising at least one impact sensor (2), at least one circuit breaker (3) configured able to stop the engine of the vehicle (1), a restart system (4) configured to deactivate the circuit breaker (3) and allow the vehicle to be restarted, and a control unit, characterized in that the restart system (4) comprises a manually operable device (5) conditioning the restarting, said manually operable device (5) being arranged at a location which is inaccessible to a driver who is in the vehicle's driver's station.

2. Immobilization device according to claim 1, in which the manually operable device (5) is arranged under the front bonnet of the vehicle (1).

3. Immobilization device according to claim 1, in which said manually operable device (5) comprises at least one base, and a handle which is movable relative to the base.

4. Immobilization device according to claim 1, in which said at least one impact sensor (2) is arranged on a bumper of the vehicle (1).

5. Immobilization device according to claim 1, wherein the at least one impact sensor (2) is a deceleration sensor and/or an bump sensor placed inside a housing, preferably a tamper-proof housing.

6. Immobilization device according to claim 1, further comprising a brake actuator configured to actuate the vehicle brakes (1) in the event of activation of the at least one impact sensor (2).

7. Immobilization device according to claim 1, further comprising a GPS beacon, as well as a transmitter, capable of sending information to a control center.

8. Use of an immobilization device according to claim 7, in which the neutralization of the circuit breaker (3) produces the sending of an alert to said control center.

9. Use of an immobilization device according to claim 1, in which the control unit is configured to be in a normally active state, such that removal or neutralization of at least one piece of equipment of the immobilization device other than the circuit breaker (3) produces activation of the circuit breaker.

10. Use of an immobilization device according to claim 3, wherein the actuation of the restart system (4) requires at least two separate movements of the handle relative to the base.
